(19) United States
(12) Patent Application Publication
(10) Pub. No.: US 2014/0343986 A1
(43) Pub. Date: Nov. 20, 2014

(54) PRODUCT NOTICE COSTING

(71) Applicant: Symberion Corp., Minneapolis, MN (US)

(72) Inventors: Vineet Sinha, Eagan, MN (US); Ajmal Nasar, Eagan, MN (US)

(73) Assignee: Symberion Corp., Minneapolis, MN (US)

(21) Appl. No.: 13/894,201

(22) Filed: May 14, 2013

(51) Int. Cl. G06Q 10/06

(52) U.S. Cl. CPC G06Q 10/063114
USPC 705/7.15

(57) ABSTRACT

Various embodiments include at least one of systems, methods, and software for product notice costing. Some embodiments include receiving a product notice and storing the product notice in a product notice database, identifying tasks associated with a product notice, and storing tasks within a product notice task database. The tasks may be sent to business personnel, and the business personnel may be prompted to update the task status. Task status updates may include entering percentage complete, cost per unit time of the business personnel, quantity of time spent completing the assigned task, or assigning a cost category. In an embodiment, the cost of multiple tasks may be aggregated, and a report may be generated including the aggregated task costs for a product notice.

### BACKGROUND INFORMATION

Product notices are issued by many different entities, such as manufacturers, distributors, retailers, government and non-government organizations, and others. Product notices are often related to product recalls, safety warnings, maintenance checks, and other such advisories.

Organizations use a large number of products in furtherance of their efforts. Monitoring notices that are issued with regard to such products that are used or sold by an organization can be a very difficult and time-consuming task. Notices relevant to products used and sold by an organization need to be identified, considered by the appropriate employees, and often, action must be taken. The larger the organization, in terms of both employee size and the number of products used and sold, the larger the effort involved. Further confounding notice monitoring is the distributed nature of many organizations across broad geographic regions.

### BRIEF DESCRIPTION OF THE DRAWINGS

FIG. 1 is a logical block diagram of a method, according to an example embodiment.

FIG. 2 is a logical block diagram of a product notification, according to an example embodiment.

FIG. 3 is a block diagram of a computing device, according to an example embodiment.

### DETAILED DESCRIPTION

Various embodiments herein include at least one of systems, methods, and software to facilitate product notice costing. At a high-level, such embodiments include at least one product notice database that is an aggregation of product notices (e.g., product advisories), such as product recalls, bulletins, safety notices, updated usage guidelines, and the like, that may be issued by various different sources. The product notice database is monitored in such high-level embodiments in view of products of an organization to identify possible matches. When a possible match is identified, the notice is obtained by the organization, and various tasks associated with the notice may be generated. Some such embodiments may further include routing the notice to particular people or departments responsible for the relevant product, or products, of the notice. The routing of notices or tasks to the particular people or departments to whom the particular notices are relevant prevents notices from being sent to those to whom the particular notice is irrelevant. As a result, notices and tasks are more likely to receive the attention needed rather than being considered a nuisance-type notice. The matching in such embodiments may be a relative match based on one or more forms of fuzzy logic or other matching algorithms, which allows for approximate matching, although not necessarily identical.

The sources of notices may be virtually any source that may provide product notices such as the Consumer Product Safety Commission (CPSC), Food and Drug Administration (FDA) notices, state departments of health or safety, other government entities, product manufacturers, distributors, wholesale and retail outlets, consumer advisory groups, user groups, and other such sources. These notices may be received or retrieved by an entity maintaining the one or more product notice databases. The product notice database in some embodiments may be monitored by a cloud-based notice research tool that receives or retrieves data from a subscribing organization of products to be monitored. The product notice database in other embodiments may be monitored by a notice research tool deployed within or otherwise used by a subscribing organization that has access to data of products to be monitored independent of the product notice database or the entity maintaining the product notice database. These and other embodiments are illustrated and described herein.

In the following detailed description, reference is made to the accompanying drawings that form a part hereof, and in which is shown by way of illustration specific embodiments in which the inventive subject matter may be practiced. These embodiments are described in sufficient detail to enable those skilled in the art to practice them, and it is to be understood that other embodiments may be used and that structural, logical, and electrical changes may be made without departing from the scope of the inventive subject matter. Such embodiments of the inventive subject matter may be referred to, individually and/or collectively, herein by the term “invention” merely for convenience and without intending to limit the scope of this application to any single invention or inventive concept if more than one is in fact disclosed. The following description is, therefore, not to be taken in a limited sense, and the scope of the inventive subject matter is defined by the appended claims.

The functions or algorithms described herein are implemented in hardware, software or a combination of software and hardware in one embodiment. The software comprises computer executable instructions stored on computer readable media such as memory or other type of storage devices. Further, described functions may correspond to modules, which may be software, hardware, firmware, or any combination thereof. Multiple functions are performed in one or more modules as desired, and the embodiments described are merely examples. The software is executed on a digital signal processor, ASIC, microprocessor, or other type of processor operating on a system, such as a personal computer, server, a router, or other device capable of processing data including network interconnection devices.

Some embodiments implement the functions in two or more specific interconnected hardware modules or devices with related control and data signals communicated between and through the modules, or as portions of an application-specific integrated circuit. Thus, the exemplary process flow is applicable to software, firmware, and hardware implementations.

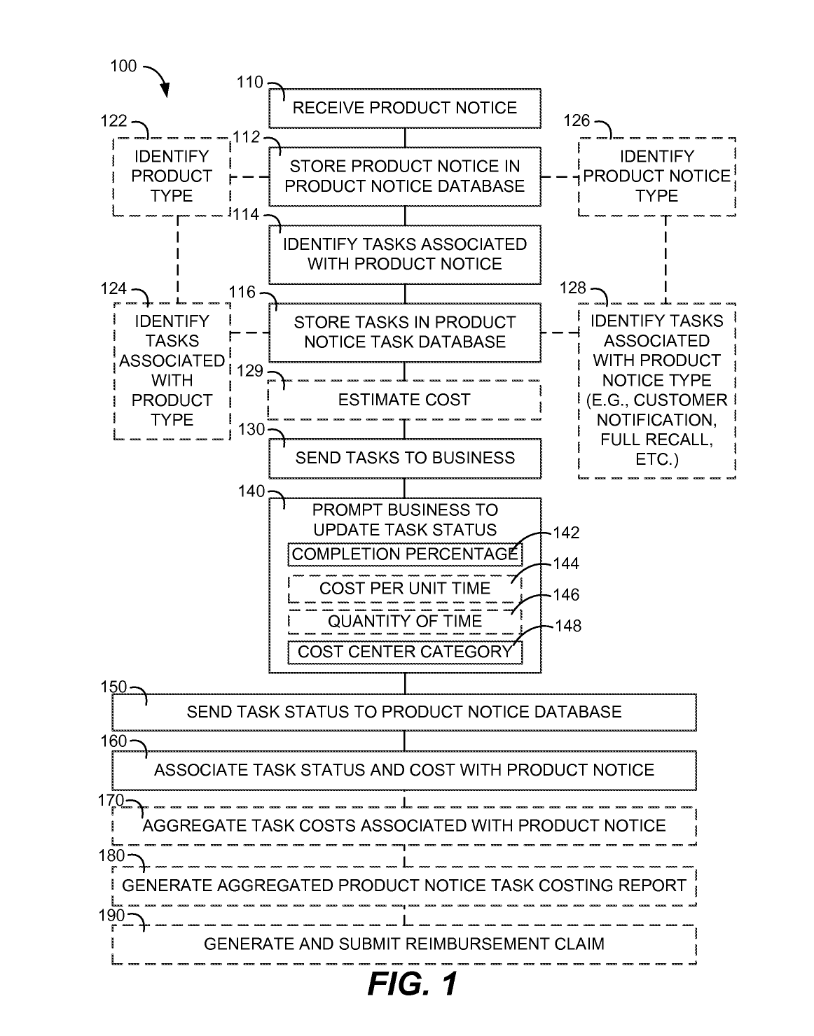

FIG. 1 is a logical block diagram of a method 100, according to an example embodiment. The method 100 is an example of various components that may be deployed in some embodiments in different computing environments to facilitate product notice costing. The example method 100 includes receiving 110 a product notice and storing 112 the product notice in a product notice database.

In some embodiments, the product notice database may be included in a computing environment of an organization or a cloud-computing environment of an entity that maintains a product notice database. Product notice services may be provided from the cloud-computing environment for one or many product notice service subscribers. The computing environment of the organization and the cloud-computing environment may be connected via at least one network. The network generally includes the Internet, but may also include one or more other networks that facilitate the connections there between or may operate thereon, such as local area networks, wide area networks, system area networks, virtual private networks, and the like.

The computing environment of the organization may include at least one product database and a notice module. Some embodiments of the computing environment of the organization may also include a routing module.

The product database may be a single database or a portion of a single database that stores data representative of products an organization uses. The product database may include products an organization has in inventory for its own use or sale, products that have been sold or previously used or otherwise deployed, products used on behalf or otherwise with regard to the organization, or other products that are somehow related to the organization. In some embodiments, the product database may instead be a process that is executed to retrieve product data from various data storage locations, which may be both internal and external to the organization. In some embodiments, the product database may be based on a purchase order history. For example, a company may only have access to the purchase order history of a customer, and could use that purchase order history to populate the product database. Product data stored in the product database may include data of many different varieties. For example, the product data may identify products by one or more of manufacturer, distributor, retailer, model number, serial number, lot number, description, version, manufacture or production date, production factory, geographic location of origin, and the like.

The cloud-computing environment may include a product notice database and a notice research tool. The cloud-computing environment may include various sources, which may exist within the cloud-computing environment.

The product notice database may include data representative of product notices issued by various entities. The product notice database may be populated with product notices in a variety of ways. For example, product notices may be received or retrieve as data formatted according a standardized product notice data format, as a text data file, or other data format. Product notices may also be entered into the product notice database by a human. In some embodiments, a product notice document may be scanned, text may be identified by an optical character recognition process, and one or both of the text and the document image may be stored to the product notice database.

Regardless of how the product notice database is populated with data of product notices, the data in the product notice database may be stored an indexed in many ways, depending on the particular embodiment. In some embodiments, records of the product notices stored in the product notice database include a plurality of data items related to one or more products the particular product notice is relevant to. Such data items may include one or more of manufacturer, distributor, retailer, model number, serial number, lot number, description, version, manufacture or production date, production factory, geographic location of origin, and the like.

In some embodiments, the notice research tool included in the cloud-computing environment of the system monitors product notices stored in the product notice database in view of products represented in the product database of the organization. The notice research tool, in some embodiments, is a process that executes on a computing device within the cloud-computing environment and exposes data and services to requestors, such as via web services. In some embodiments, the notice research tool may access the product database to obtain data with regard to products represented therein and determine if there are any product notices represented in the product notice database relevant to those products. In other embodiments, the notice module within the computing environment of the organization may submit queries to the notice research tool with regard to individual products represented in the product database. In further embodiments, the notice module may submit product data with regard to a plurality of products represented in the product database to the notice research tool. In such embodiments, the notice research tool upon receipt of product data from the notice module determines whether there are any relevant product notices included in the product notice database associated with each product represented in the received product data. Thus, in various embodiments, the determination of whether product notices are represented in the product notice database relevant to products represented in the product database can be driven, or triggered, from either the notice research tool or the notice module.

Typical embodiments of the notice research tool also include mechanisms to prevent sending the same product notice to the notice module more than once. Such mechanisms may include a table in the notice database where entries are made with regard to a product notice when sent. Then prior to sending a notice, the table is queried to determine if the notice was previously sent. In some embodiments, the query of the notice database may contemplate data in that table to avoid an additional database operation. In other embodiments, a record of notices sent may be maintained and stored in a different data structure, such as a file. Other mechanisms may be included in various embodiments depending on design preferences, database usage and available capacity, and other factors and requirements of particular embodiments.

The triggering of the determination may be in response to a user submitted command to either the notice module or the notice research tool. In other embodiments, the triggering of the determination may automatic in view of a configuration setting that identifies a periodic basis at which the determination is to be performed, a scheduling of the determining such as at a time when network or system usage is relatively low, or other automatic triggering scheme.

In some embodiments, the notice research tool uses a fuzzy logic algorithm to determine whether products represented in the product database, or as identified in a query received from the notice module, have relevant notices in the product notice database is performed. Because the data in the product notice database may not be normalized in a same manner as product data stored in the product database, use of fuzzy logic allows likely matches to be identified.

The fuzzy logic in some embodiments uses a scoring scheme and at least one threshold value to declare a likely match between a product represented in the product database and a product notice in represented in the product notice database. For example, if a model number is matched, a score of 100, 100%, 1.00, or other such value may be attributed to the match and the product notice will be forwarded to the notice module within the computing environment of the organization. Another example may involve a less certain matching, such as a match of a product descriptions and manufacturing dates, but a mismatch or missing data with regard to other data elements such as a missing lot number included in a product record of the product database. In such a situation, a score value may be counted for each match, such as 10 points, 10%, or other scoring value, the scores may be summed, and then the sum compared against a threshold value. When the threshold is met, the product notice will be forwarded by the notice research tool to the notice module within the computing environment of the organization. The threshold, in some embodiments, is a configurable parameter. Thus, if an organization finds too many irrelevant product notices are being identified, the threshold can be adjusted higher, and vice versa.

When the notice research tool forwards a product notice to the notice module, the notice module may retrieve the product notice from the product notice database and forward the data of the product notice, such as through the routing module. In other embodiments, a hyperlink or other network address of the product notice from which the product notice may be retrieved is forwarded. The product notice may also be provided in other ways depending on the particular embodiment. In some embodiments, regardless of how the product notice is forwarded to the notice module, a relevancy score may also be provided. The relevancy score will typically be a score of, or derived from, the fuzzy logic matching algorithm that indicates a degree to which the match was made or a likely relevance of the identified product notice. In addition, when a product notice is forwarded to the notice module, an identifier of one or more products the notice is determined to pertain to is also typically included.

The notice research tool may forward the product notices to the notice module in a number of different ways, depending on the particular embodiment. In one embodiment, product notices may be sent as formatted data directly to the notice module of the network. The notice module in such embodiments may include a data interface for this purpose. In other embodiments, the notice research tool may cache product notices to be sent, and subsequently send an indication to the notice module that product notices are available for download. The notice module, in such embodiments, may then download the product notices, either automatically or upon receipt of a command from a user, such as a product notice administrator of the organization. In another embodiment, the identified product notices may be attached by the notice research tool to one or more emails that are then sent to an email address associated with the notice module. In other embodiments, the notice research tool may send the identified product notices in other ways, as will be readily apparent to a person having ordinary skill in the art.

The notice module will process the product notice upon receipt of a product notice from the notice research tool, regardless of whether the product notice was pushed by the notice research tool or retrieved from the notice research tool. The processing of a product notice by the notice module includes storing the product notice and other data received therewith. When the data included with the product notice includes a hyperlink or other network address from which to download the product notice, the notice module may download and store the actually product notice based on the hyperlink or other network address. The notice module, in some embodiments, may also route received product notices by forwarding a product notice to, or otherwise calling, the routing module.

The routing module typically routes product notices based on routing logic applied to additional data. The additional data used by the routing logic may include data such as location or assignment data with regard to products in the product database. Location data may indicate where respective products are stored, used, or are otherwise located. Notices may then be routed to a person or department responsible for such areas as may be defined elsewhere in data. Assignment data is similar to location data, but instead is data that associates respective products to people, roles, or departments responsible in some way for a particular product represented in the product database. A product may be associated with one or more of both of a location and an assignment and even a plurality of one or both. Once the routing destination(s) are determined by the routing module, the routing module may then communicate the product notices in any number of ways. For example, notices may be sent via email, within a workflow system that may also track actions taken and tasks performed with regard to notices, printed and sent via intra-organization mail, and other electronic and out-of-band mechanisms, systems, and arrangements.

Routing logic within the routing module may be used to route notices to those to whom the notices are more likely relevant. Similarly, routing logic may be used to avoid routing notices to those to whom the notices are unlikely to be relevant. For example, personnel working in department A should not receive notices that are relevant only to department B. Routing logic may also be used within an organization to route a notice automatically to the appropriate personnel. For example, a manager may receive a notice, the routing logic could determine that the notice is not relevant to the manager, and allow him or her to convey the notice automatically or based on a set of routing logic rules. In another example, a notice may be related to a specific machine, and that notice may be routed automatically to a specific person or department without requiring prior review or approval by a manager. As a result, upon receipt of a notice, the user is more likely to actually review the notice as it is more likely to be relevant than not. By eliminating irrelevant notices, the system of the particular embodiment becomes more useful and reliable.

Once a product notice is stored 112 within a database, the example method 100 identifies 114 tasks associated with a product notice, and stores 116 a representation of the identified tasks within a product notice task database. The database used to store 112 the product notice may be the same database as the database used to store 116 the product notice task, or two or more databases may be used. In an embodiment, one or more tasks may be based on the type of product. For example, a particular product may be associated with a minimum set of tasks, such as a bicycle mechanical failure requiring identifying and contacting all distributors. The method 100 may respond to a product notice by identifying 122 the product type, and identifying 124 one or more tasks associated with that product type. In another embodiment, one or more tasks may be based on the type of product notice. For example, a particular product notice type may be associated with a minimum set of tasks, such as a tire failure requiring immediate contacting of all tire owners and an immediate recall of all related tires. The method 100 may respond to a product notice by identifying 126 the product type, and identifying 128 one or more tasks associated with that product type.

In the example method 100, after a set of tasks have been stored 116 in a product notice task database, a cost may be estimated 129 based on one or more tasks in the product notice database. The cost may be estimated based on various individual factors. For example, the cost may be estimated based on the type of task, the number of tasks, the urgency of the task, minimum charges associated with the task, flexibility as to quantity of time required to complete the task, cost per unit time (e.g., hourly rates) for various employee roles, the type of employee role that may be used to perform the task, or other factors. The cost may be estimated based on a combination of factors. For example, a task requiring contacting owners of a product may have an associated task unit cost, and the task unit cost may be multiplied by an estimated number of customers, where the estimated number of customers may be estimated based on the number of products sold.

In the example method 100, after a set of tasks have been stored 116 in a product notice task database and a cost estimated 129, the tasks and estimates may be sent 130 to a business that will execute the task. In some embodiments, the cost estimates are used within the business. In other embodiments, the cost estimates may also be sent to the manufacturer or a claims processing entity designated by the manufacturer. The tasks may then be presented to personnel within the business, and the example method 100 may prompt 140 the business personnel to update the task status. Prompting 140 the business personnel to update the task status may include updating 142 the task completion percentage, entering 144 the cost per unit time of the personnel who performed work on the task, updating 146 the quantity of time spent completing the assigned task, and assigning 148 a cost category. For example, a cost category may include entering an employee role, such as whether the employee is a manager, and the cost per unit time may be calculated automatically by the system based on the employee role. Entering an employee role may include choosing from among a predetermined set of roles. For example, a task may require five hours of entry-level employee time and one hour of management time, and entering an employee role may include choosing between “Entry-Level Employee” and “Manager” roles. A cost category may include information about the type of work required for each task. For example, the types of work may include analyzing the notice or task, performing research to understand how to carry out the task, or completing the task itself.

In the example method 100, after the business personnel have completed updating 140 the task status, the task status may be sent 150 to a product notice database, which may be the same as the product notice database in which the product notice was first stored 112. The task status and cost may then be associated 160 with the product notice. Various algorithms or configurations may be used to convert estimated or actual time to estimated or actual cost. Cost translation logic could be used to generate a cost based on completion percentage, cost per unit time, quantity of time, or a cost center category. In an example, a specific rate may be charged based on the skill of the person. In another example, any task corresponding to a short duration (e.g., ten minutes) may not be included in the cost.

In an embodiment, the cost of multiple tasks may be aggregated 170, and may be associated with a product notice. In another embodiment, the method 100 may generate 180 an aggregated product notice task costing report for a product notice. The costing report may include various elements of costing information. For example, the costing report may include a list of which tasks were performed by which personnel, the cost per unit time for each task, the aggregated cost for all tasks, and other costing information.

Tracking individual and aggregated reimbursements may enable a company to identify the actual cost of a recall, and to substantiate reimbursement claims. Using the aggregated task costs, the method 100 may generate and submit 190 a reimbursement claim for the aggregated task cost. The reimbursement claim amount may be for the full value of the aggregated task cost, or it may be for a partial reimbursement based on a proportion of the task completed. The reimbursement may be payable to a single entity, or may be proportionally allocated to various company departments, company regions, or company cost centers. Partial reimbursement enables subgroups to submit product recall expense costing reports to product manufacturers as costs are incurred. For example, if the purchase of additional medical supplies was required to begin other tasks related to the product recall, the medical supply expenses could be submitted and reimbursed before other tasks are completed. In the example method 100, costs may be aggregated for partial completion of multiple tasks or product notice subgroups associated with a product notice. For example, a product notice subgroup may be associated with a geographic location or region, or a product notice subgroup may be associated with predetermined task assignments. The use of product notice subgroups may allow for partial reimbursement. For example, if a first hospital completes a set of tasks quickly but a second hospital is unable to complete the task, product notice subgroups may allow an organization to record partial task completion and process partial reimbursement for the first hospital. In an embodiment, costs may have associated priority values, and task costs may be reimbursed according to their priority value. For example, if out-of-pocket expenses have a higher category than departmental expenses, then out-of-pocket expenses would be reimbursed before departmental expenses.

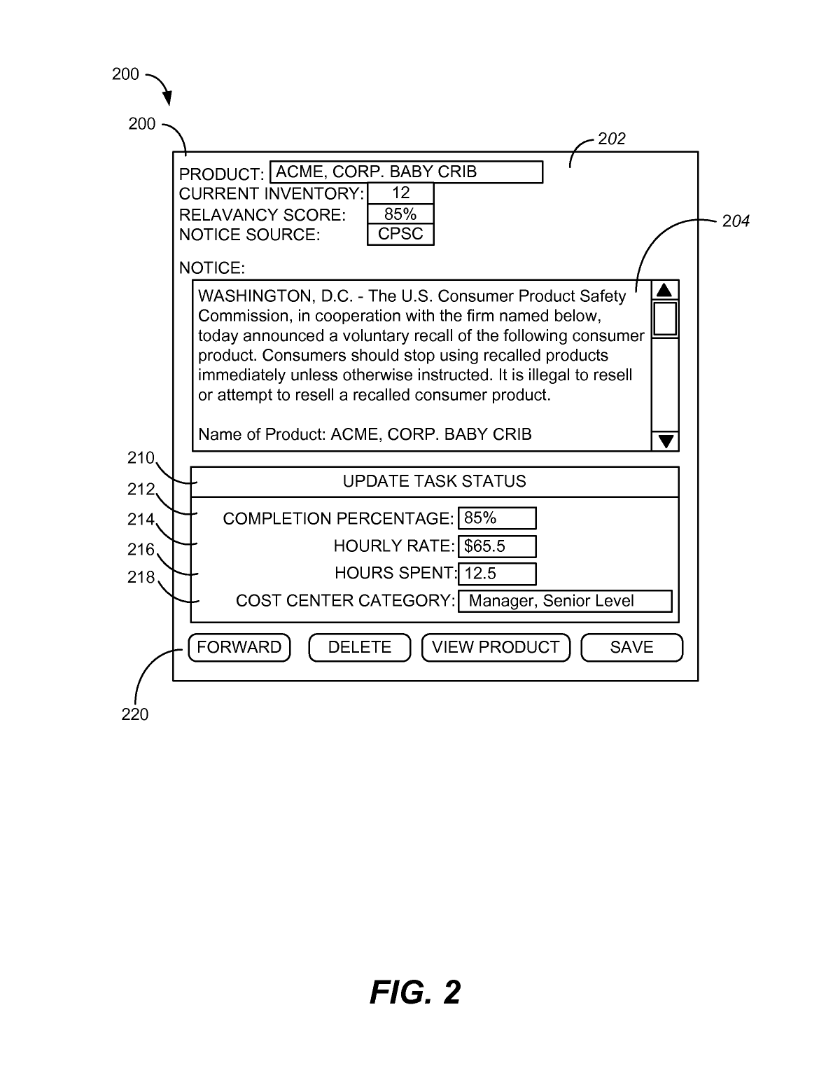

Thus, the method 100 of FIG. 1 provides a cloud-based computing solution allowing organizations to monitor product notices closely and accurately. Further, other architectural modifications may be made in different embodiments, or to accommodate differing system requirements. For example, FIG. 2 illustrates a user interface through which multiple functions may be facilitated.

The prompting 140 of business personnel to update task status of FIG. 1 may include various user interfaces for various functions. Such functions may include viewing of product notices, viewing one or more queues of product notices that have been determined as likely relevant to at least one product, and triggering or scheduling a check of the product notice database for product notices. Some other functions that may be facilitated through user interfaces of the notice module may include receiving input with regard to actions taken with regard to product notices (i.e., ignore the notice, return of product to the manufacture, perform remedial action to the product, etc.), forwarding product notices to other individuals, groups, or departments, or other functions. An example of one such user interface is provided in FIG. 2.

FIG. 2 is a user interface 200 illustration, according to an example embodiment. The example user interface 200 is a user interface through which multiple functions may be facilitated. For example, the user interface 200 presents 204 a product notice to a viewer in a notice-viewing portion with regard to a product identified in various fields 202 of the user interface 202.

The user interface 200 may also present additional data in the various fields, such as a current inventory of the identified product, which may be obtained from the product database, or other database of the particular embodiment. The inventory field allows the viewer to determine quickly if the product is still in use or being offered for sale, which may influence a decision of an action that may need to be taken with regard to the product notice presented in the notice-viewing portion 204.

The various fields 202 may also include data indicative of the relevancy score of the product notice with regard to the particular product that may have been identified 114 by the notice research tool 214 as discussed above with regard to FIG. 1. The relevancy score in various embodiments may indicate to the viewer how likely it is that the product notice pertains to the actual product identified in the user interface.

A source of the notice may also be presented in the various fields 202, such as the Consumer Product Safety Commission (CPSC). The source of a notice may be of particular importance with regard to some notices, such as when the notice is from a governmental entity that may also have regulatory authority over the organization to require that certain actions be taken with notices. The source may also be helpful to inform the view as to the veracity, severity, and importance of the notice.

In some embodiments, the various fields 202 may include different numbers of fields that convey some of the same and different information with regard to notices. For example, in a hospital setting, for a product that may be installed in or otherwise used with regard to a patient, an additional field may be presented to indicate a number of patients possibly impacted by the product notice. Another example in a retail setting may present not only a current inventory, but also data indicative of a number of the product sold and another field with data indicative of a number of the product on order. Thus, the data presented in the various fields may differ between embodiments based on a number of factors including the context within which the embodiment is implemented.

The user interface 200 may include an area where business personnel can update the task status 210. For example, updating the task status 210 may include updating the task completion percentage 212, entering the cost per unit time of the business personnel who performed work on the task 214, updating the quantity of time spent completing the assigned task 216, and assigning a cost category 218. For example, a cost category may include entering an employee role, such as whether the employee is a manager.

The user interface 200 may include a set of action buttons 220. The action buttons 220 may enable a viewer to take actions with regard to a notice being viewed. For example, the viewer may choose a forward button to cause the viewed product notice to be forwarded (via a workflow system, email, or other communication mechanism) to another individual, department, company, and the like. The viewer may also be presented with and choose a delete button to cause the viewed product notice to be discarded or ignored. Another of the action buttons 220 may provide a viewer the ability to view the product or at least further detailed data with regard to the product. A further of the action buttons 220 may allow the viewer to save the viewed product notice for consideration at a later time, archiving, or other purposes.

In other embodiments, the user interface 200 and other user interfaces may be customized to the needs of a particular embodiment, a particular organization utilizing the embodiment, to a particular user's needs or desires, and the like. For example, different fields may be added or removed, a notes field may be included to allow for work-in-progress or other notes to be added, additional action buttons may be provided that are relevant to different actions that may be taken with regard to a notice, and other such modifications and customization.

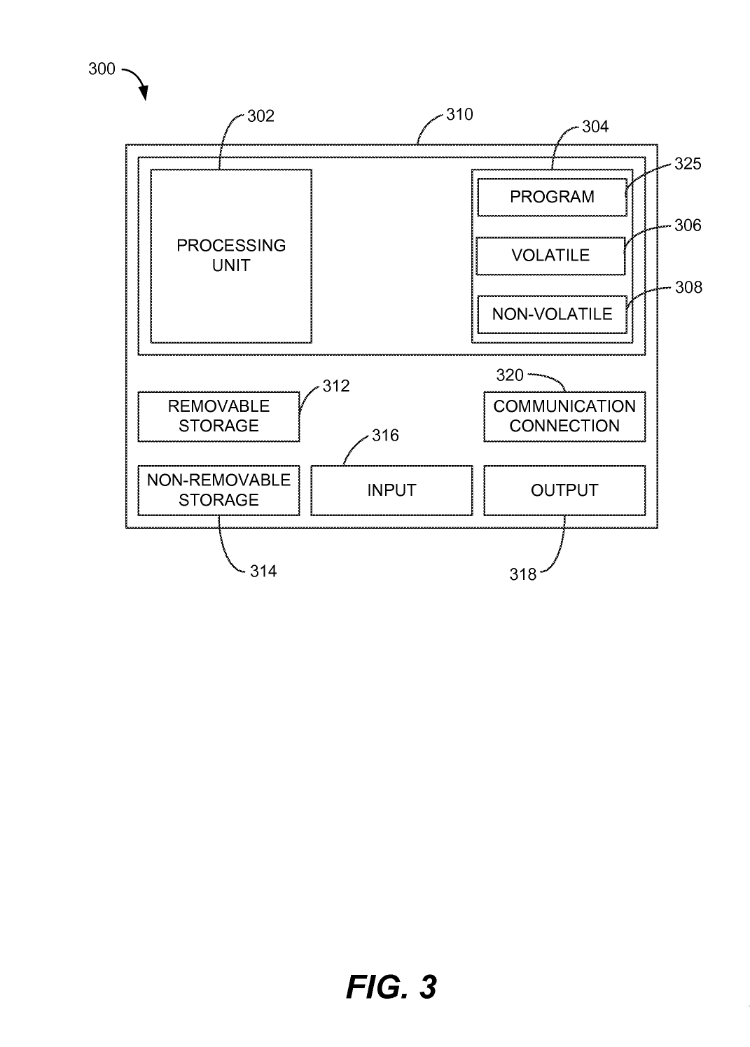

FIG. 3 is a block diagram of a computing device, according to an example embodiment. In one embodiment, multiple such computer systems are used in a distributed network to implement multiple components in a transaction-based environment. An object-oriented, service-oriented, or other architecture may be used to implement such functions and communicate between the multiple systems and components. In an example, a computing device in the form of a computer 310 may include a processing unit 302, memory 304, removable storage 312, and non-removable storage 314. Memory 304 may include volatile memory 306 and non-volatile memory 308. Computer 310 may include—or have access to a computing environment that includes—a variety of computer-readable media, such as volatile memory 306 and non-volatile memory 308, removable storage 312 and non-removable storage 314. Computer storage includes random access memory (RAM), read only memory (ROM), erasable programmable read-only memory (EPROM) & electrically erasable programmable read-only memory (EEPROM), flash memory or other memory technologies, compact disc read-only memory (CD ROM), Digital Versatile Disks (DVD) or other optical disk storage, magnetic cassettes, magnetic tape, magnetic disk storage or other magnetic storage devices, or any other medium capable of storing computer-readable instructions. Computer 310 may include or have access to a computing environment that includes input 316, output 318, and a communication connection 320. The computer may operate in a networked environment using a communication connection to connect to one or more remote computers, such as database servers. The remote computer may include a personal computer (PC), server, router, network PC, a peer device or other common network node, or the like. The communication connection may include a Local Area Network (LAN), a Wide Area Network (WAN) or other networks.

Computer-readable instructions stored on a computer-readable medium are executable by the processing unit 302 of the computer 310. A hard drive, CD-ROM, and RAM are some examples of computer-readable mediums, which are also non-transitory computer-readable mediums. For example, a computer program 325 capable of performing one or more, or portions, of the various methods illustrated and described herein.

It will be readily understood to those skilled in the art that various other changes in the details, material, and arrangements of the parts and method stages which have been described and illustrated in order to explain the nature of the inventive subject matter may be made without departing from the principles and scope of the inventive subject matter as expressed in the subjoined claims.

What is claimed is:

1. A method comprising:
receiving, over at least one network, a product notice from a product manufacturer;
generating a task associated with the product notice;
sending, over the at least one network, the task to a business;
receiving, over the at least one network, a task status and a task cost from the business; and
associating, responsive to receiving the task status and task cost, the task status and the task cost with the product notice.

2. The method of claim 1, further comprising:
generating, responsive to receiving the task status and the task cost, a reimbursement claim based at least in part on the received task cost; and
sending, over the at least one network, the reimbursement claim to the product manufacturer.

3. The method of claim 1, wherein receiving the task cost from the business includes receiving data identifying a quantity of time for performance of the task and an employee role of an employee-type to perform the task, and wherein the employee role is associated with the cost per unit of time.

4. The method of claim 1, wherein receiving the task status from the business includes:
receiving data identifying a task completion percentage; and
calculating, based at least in part on the received task status, an estimated product notice completion percentage.

5. The method of claim 1, wherein generating the task associated with the product notice includes identifying a product type and identifying at least one task associated with the product type.

6. The method of claim 1, further comprising aggregating, responsive to associating the task status and the task cost with the product notice, the received task costs associated with the product notice and generating a report based at least in part on the aggregated task costs.

7. The method of claim 1, further comprising:
storing the product notice in a product notice database; and
storing the task in the product notice database.

8. A method comprising:
receiving, over at least one network, a product notice;
generating a task and an estimated task cost associated with the product notice;
sending, over the at least one network, the task and the estimated task cost to a business;
receiving, over the at least one network, a task status and a task cost from the business; and
associating, responsive to receiving the task status and task cost, the task status and the task cost with the product notice.

9. The method of claim 8, further comprising:
generating, responsive to receiving the task status and the task cost, a reimbursement claim based at least in part on the received task cost; and
sending, over the at least one network, the reimbursement claim to the product manufacturer.

10. The method of claim 8, further comprising generating, based at least in part on a comparison between the received task cost and the estimated task cost, a task completion percentage report.

11. The method of claim 8, further including:
receiving a task cost center category from a product manufacturer, wherein the task cost center category is used to generate the estimated task cost associated with the task; and
sending, over the at least one network, the task and the estimated task cost to the manufacturer.

12. A non-transitory computer-readable medium, with instructions stored thereon which when executed by at least one processor of at least one computing device, cause the at least one computing device to:
receive, over at least one network, a product notice from a product manufacturer;
generate a task associated with the product notice;
send, over the at least one network, the task to a business;
receive, over the at least one network, a task status and a task cost from the business; and
associate, responsive to receiving the task status and task cost, the task status and the task cost with the product notice.

13. The non-transitory computer-readable medium of claim 12, wherein the instructions are further executable to cause the at least one computing device to:
generate, responsive to receiving the task status and the task cost, a reimbursement claim based at least in part on the received task cost; and
send, over the at least one network, the reimbursement claim to the product manufacturer.

14. The non-transitory computer-readable medium of claim 12, wherein the receipt of the task cost from the business includes the receipt of data identifying a quantity of time for performance of the task and an employee role of an employee-type to perform the task, and wherein the employee role is associated with the cost per unit of time.

15. The non-transitory computer-readable medium of claim 12, wherein the instructions are further executable to cause the at least one computing device to:
receive data identifying a task completion percentage; and
calculate, based at least in part on the received task status, an estimated product notice completion percentage.

16. The non-transitory computer-readable medium of claim 12, wherein the generation of the task associated with the product notice includes the identification of a product type and the identification of at least one task associated with the product type.

17. A system comprising:
at least one processor, at least one memory device, and at least one network interface device; and
a product notice costing module stored on the at least one memory device and executable by the at least one processor to:
receive, over at least one network, a product notice from a product manufacturer;
generate a task associated with the product notice;
send, over the at least one network, the task to a business;
receive, over the at least one network, a task status and a task cost from the business; and
associate, responsive to receiving the task status and task cost, the task status and the task cost with the product notice.

18. The system of claim 17, wherein the product notice costing module is further executable by the at least one processor to:
generate, responsive to receiving the task status and the task cost, a reimbursement claim based at least in part on the received task cost; and
send, over the at least one network, the reimbursement claim to the product manufacturer.

19. The system of claim 17, wherein the receipt of the task cost from the business includes the receipt of data identifying a quantity of time for performance of the task and an employee role of an employee-type to perform the task, and wherein the employee role is associated with the cost per unit of time.

20. The system of claim 17, wherein the product notice costing module is further executable by the at least one processor to:
receive data identifying a task completion percentage; and
calculate, based at least in part on the received task status, an estimated product notice completion percentage.
